(19) United States
(12) Patent Application Publication
(10) Pub. No.: US 2002/0188628 A1
(43) Pub. Date: Dec. 12, 2002

(54) Editing interactive content with time-based media

(76) Inventors: Brian Cooper, Foxboro, MA (US); Michael Phillips, Melrose, MA (US); Larisa Fay, Andover, MA (US)

Correspondence Address: PETER J. GORDON, PATENT COUNSEL, AVID TECHNOLOGY, INC., ONE PARK WEST, TEWKSBURY, MA, 01876, US

(21) Appl. No.: 09/838,782

(22) Filed: Apr. 20, 2001

(51) Int. Cl. G09G 5/12

(52) U.S. Cl. 707/500.1

(57) ABSTRACT

An editing system has a timeline interface with at least one interactive track for interactive content and at least one track for time-based media. Interactive content may be associated with a point in time on the at least one track for interactive content. A user may place interactive content on the at least one interactive track. The user may select whether the interactive content is associated with a point in time using a locator object, or with a duration using a source clip object. A bin stores interactive content. The interactive content is imported into the bin such that interactive content in the bin is associated with a unique reference. A user may place interactive content selected from the bin on the interactive track. Information about the interactive content in the bin may be updated by using the unique reference. For a trigger element, the unique reference may be a file name for a trigger file that includes a description of the trigger element and a unique identifier of the trigger element. The interactive content may include display information indicating information to be displayed with the video and a specification of size and position of the video. If the program specified by the timeline interface is played back, the specification of the size and position of the video for the interactive content corresponding to a point in time in the program is accessed. The video and the display information of the interactive content is displayed according to the specification at this point in time in the program. The editing application also may be programmed to allow a user to use a conventional operation to select the content in the bin or on the interactive track. The editing application then can cause the associated authoring tool to launch, access and open for editing the interactive content associated with the object in the bin or on the interactive track.

### BACKGROUND

Interactive programs that combine time-based media with interactive content generally are created using one of two approaches. The first approach involves creating time-based media as an element of the interactive program, in which interactive content refers to some time-based media. The other approach involves creating a time-based program, and then associating interactive content at different points in time in the time-based program. In both such approaches, the time-based media is created upfront and then is provided to editors of interactive content who embellish the time-based media with interactive content to produce the final interactive program.

Creation of an interactive program with interactive content and time-based media would be improved by having several people working simultaneously on both the interactive content and the time-based media to create the interactive program for multiple delivery formats.

### SUMMARY

In an aspect, an editing system has a timeline interface with at least one interactive track for interactive content and at least one track for time-based media. A user may place interactive content on the at least one interactive track. The user may select whether the interactive content is associated with a point in time using a locator object, or with a duration using a source clip object.

In an embodiment, a bin may be used to store interactive content. The interactive content may be imported into the bin, so that information about the interactive content is stored with the editing system. If a user places interactive content selected from the bin on the interactive track, this information may be stored as an attribute of the object used for the interactive content. The object types used for time-based media and interactive content are the same. Thus interactive content inherits the behavior of the time-based media. In this manner, editing operations such as cutting, trimming, splicing and overwriting media, and addition of effects, may be used in their conventional manner to edit both time-based media and interactive content together and maintain frame accurate synchronization between the interactive content and the time-based media.

In an embodiment, a kind of interactive content is a trigger element. A trigger element stores an indication of an operation to be initiated at a point in time during playback of time-based media. A trigger element may indicate information about the size, position and orientation of display of the time-based media. A trigger element also may indicate a duration or synchronization information. For example such information may be extracted from a document referenced by a trigger element. Each trigger element is assigned a unique identifier. This unique identifier may be used to track the trigger element among different machines and to allow the trigger element to be modified by one user while another user uses the trigger element in an edited program. A user may have information about a trigger element refreshed by using a file name for a trigger file containing the description of the trigger element, and a unique identifier of the trigger element to access the description of the trigger element.

In an aspect, an editing system has a timeline interface for specifying a program. The timeline interface has at least one interactive track for interactive content and at least one track for time-based media. The interactive content may be associated with a point in time on the at least one interactive track. A bin stores interactive content. The interactive content is imported into the bin such that interactive content in the bin is associated with a unique reference that may be used to access the interactive content from another source. A user may place interactive content selected from the bin on the interactive track. Information about the interactive content in the bin may be updated by using the unique reference. The unique reference may be a uniform resource locator or other reference to a file containing the interactive content. If the interactive content is a trigger element, the unique identifier may include a file name for a trigger file containing the description of the trigger element, and an identifier of the trigger element that is unique within the trigger file.

In an aspect, an editing system has a timeline interface for specifying a program. The timeline interface has at least one interactive track for interactive content and at least one track for video. The interactive content may be associated with a point in time on the interactive track. A user may place interactive content on the interactive track. The interactive content includes display information indicating information to be displayed with the video and a specification of size and position of the video. If the program specified by the timeline interface is played back, the specification of the size and position of the video for the interactive content corresponding to a point in time in the program is accessed. The video and the display information of the interactive content is displayed according to the specification at this point in time in the program.

The editing application also may be programmed to allow a user to use a conventional operation to select the content in the bin or on the interactive track. The editing application then can cause the associated authoring tool to launch, access and open for editing the interactive content associated with the object in the bin or on the interactive track.

### BRIEF DESCRIPTION OF THE DRAWINGS

FIG. 1 is an illustration of a graphical user interface enabling editing of time-based media and interactive content on a timeline.

FIG. 2A is an illustration of example data for a trigger element.

FIG. 2B is an illustration of example data for other interactive content.

FIG. 3 is a flowchart describing how interactive content is imported into a bin.

FIG. 4 is a diagram illustrating a multi-user system for editing time-based media and interactive content.

FIG. 5 is a flowchart describing how interactive content is refreshed.

### DETAILED DESCRIPTION

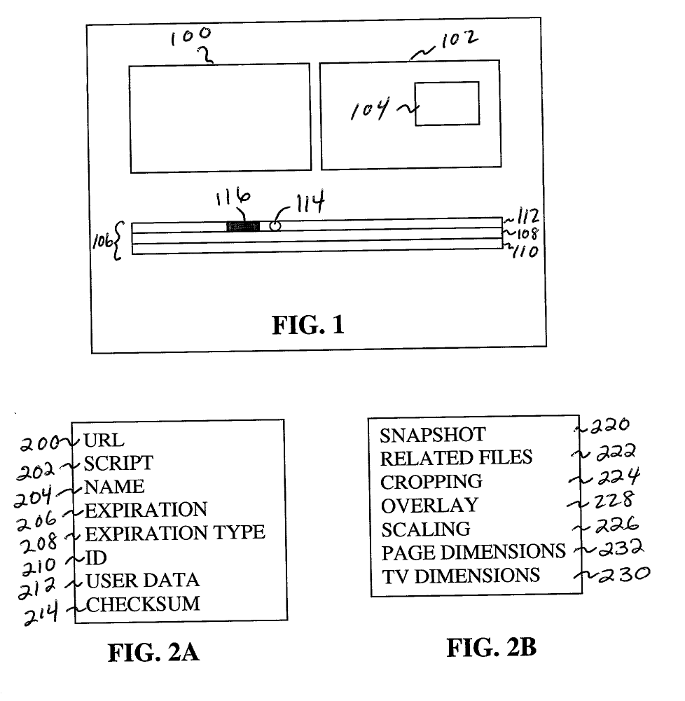

FIG. 1 illustrates an example user interface for a system for editing time-based media, such as video and audio, along with interactive content to create an interactive program. Interactive content may include documents defined in a markup language, documents of multiple media types, documents generated by the execution of a script or other computer program that is executed during program, instructions or command signals sent to equipment, or other events or actions having a specified time during the interactive program.

The user interface in FIG. 1 includes a source window 100 for displaying source media and a record window 102 for displaying an edited program. Within the record window, video may be displayed in a smaller region 104 according to a specification of the video size by associated interactive content, as described in more detail below. A timeline 106 represents the edited program, and includes one or more interactive tracks 112 and one or more time-based media tracks, such as one or more video tracks 108 and one or more audio tracks 110.

In general, a user may select a source of time-based media from one or more “bins”, not shown, which may be viewed in the source window 100. The user may select in and out points in the time-based source to designate a clip which may be added to a sequence of clips representing the edited program in the timeline 106. To associate interactive content with a point in time in the edited program, interactive clips are defined and added to the bins. A user may select one or more interactive clips from a bin for placement on the interactive timeline. Information associated with a selected interactive clip may be viewed in the source window 100. The user may select an interactive track 112 and a point in time in the track at which the interactive clip should be added. The interactive clip may be added at a point in time, as specified by a locator object 114 (described below), or may be added over a range of time, as specified by a source clip object 116 (described below). Time-based media also may be specified using source clip objects and locator objects. Because the object types used for time-based media and interactive content are the same, interactive content inherits the behavior of the time-based media. In this manner, editing operations such as cutting, trimming, splicing and overwriting media, and addition of effects, may be used in their conventional manner to edit both time-based media and interactive content together and maintain frame accurate synchronization between the interactive content and the time-based media.

An edited program may be defined using any of several data structures, which may be stored in any of a number of formats. For example, a system may use structures corresponding to the Advanced Authoring Format (AAF) specification, Open Media Framework (OMF) specification, or structures described in U.S. Pat. Nos. 6,061,758 and 5,754,851. In general, the data structure representing the edited program allows each track to be defined as a list of components, such as clips, that are played sequentially, with each track being played concurrently and in synchronization. Kinds of clips may include source clips that reference time-based media and interactive clips, of which there are several types described in more detail below.

One kind of interactive content is called herein a “trigger element.” A trigger element is an element that stores an indication of an operation to be initiated at a point in time during playback of time-based media. Such operations may involve displaying pictures, graphics, images or other information, or other actions such as sending control signals to various devices. Control signals to equipment could be used in some applications, such as ride simulators. Information that may be defined by a “trigger” is specified, for example, in the Advanced Television Enhancement Forum (ATVEF) specification. Other information specified by this and other interactive television formats may be used. A trigger element also may indicate a duration or synchronization information. A trigger element also may indicate information about the size, position and orientation of display of time-based media associated with it. For example such information may be extracted from a document referenced by a trigger element.

An example trigger element is defined by information shown in FIG. 2A. In particular, an indication of a type of the trigger element 200 is provided. For example, a uniform resource locator (URL) 200 or other file name may be used to indicate information to be displayed along with the time-based media. If the trigger element describes, for example, instructions to a ride simulator controller, field 200 might indicate that a ride simulation function is to be performed. An indication of a script 202, such as a Java script program or other computer program code to be executed, may be included. Other information may include a name 204 for the trigger element. This name field may be used as a name or as a readable text description of the trigger element. Expiration information 206, such as a date and time, and expiration type 208 (indicating whether the expiration information indicates a duration of time the trigger element is valid or a time at which the trigger element expires) also may be provided. Each trigger element also is assigned a unique identifier. An identifier field 210 stores an identifier of the trigger element. One or more additional fields 212 may be used to store user data. A checksum 214 may be included to allow detection of corrupted data. The description of one or more trigger elements may be stored in a file, called a trigger file. The unique identifier of the trigger element is unique within that trigger file.

If the trigger element specifies a URL, e.g., at 200, information such as shown in FIG. 2B may define the trigger element further. This information may include a snapshot 220 of the displayed document retrieved from the URL, any linked files 222, and any indication of cropping 224, scaling 226 or overlay 228 of the video, and the dimensions and position 230 of the video within the displayed document. The dimensions of the displayed document 232 also may be defined. The information shown in FIG. 2B also is an example of the kinds of information that may be used to specify types of interactive content that are not trigger elements, such as a document in a markup language such as HTML or the eXtensible Markup Language (XML).

As noted above, information defining a trigger element, such as in FIG. 2A, may be stored as a data file, herein called a “trigger file,” in a directory in a file system, for example in either local or shared storage. A trigger file may contain information describing any number of trigger elements. The trigger file may be specified using a markup language such as XML according to a document type definition (DTD) that may be defined for trigger files. An example of such a DTD is provided in Appendix A. A trigger file also may be designed to be in accordance with the ATVEF XML specification for triggers, for example as defined in section 1.1.5 of version 1.1 of the specification. A trigger application may be used to create and modify trigger files. The trigger application may be any application that may be used to generate an XML file or file in other suitable format, such as a character delimited file, that may be used to specify fields and associated data for those fields. A spreadsheet application or word processing application, for example, may be used. Using an XML file format that is defined by a document type definition allows the format of each trigger file to be validated. The trigger application may be used to assign a unique identifier (UID) to each trigger element that it creates, or such UIDs may be assigned manually into a trigger element. The UID for a trigger element is stored in the trigger file. The UID need not be a global unique identifier (GUID), but may be unique only within the trigger file.

To allow insertion of interactive content, including trigger elements, into a program, the interactive content may be imported into bins for access by the editing system. After interactive content is imported, the interactive content is represented by a clip or other object in the bin, with information describing the interactive content stored as an attribute of the clip or other object. An attribute is, in general, a data field of a component that is used to store a variety of user defined data.

For example, if a trigger element is imported into a bin, the bin stores a unique reference for the trigger element by storing the file name of its trigger file and its unique identifier in that trigger file. The bin captures the information defining the trigger element from the trigger file and optionally other information from files associated with the trigger element, such as the information shown in FIGS. 2A (and a UID of the trigger element) and 2B. For example, if the trigger element includes a reference to information to be displayed with the video data or about the display of the video data, this information also may be extracted and stored with the information about the trigger element in the bin. Similarly, a document in a markup language, or other interactive content, may be processed to extract information about the document, such as the information described above in connection with FIG. 2B. This information and the file name of the trigger file is stored as an attribute of a clip or other object.

Thus, kinds of interactive clips in a bin may include HTML clips that reference hypertext markup language (HTML) (or other markup language) data, trigger clips that reference information about trigger elements, and linked trigger clips that reference both information about trigger elements and HTML (or other markup language) content. The type of a clip (whether HTML, Trigger or Linked Trigger) depends on the attributes associated with it.

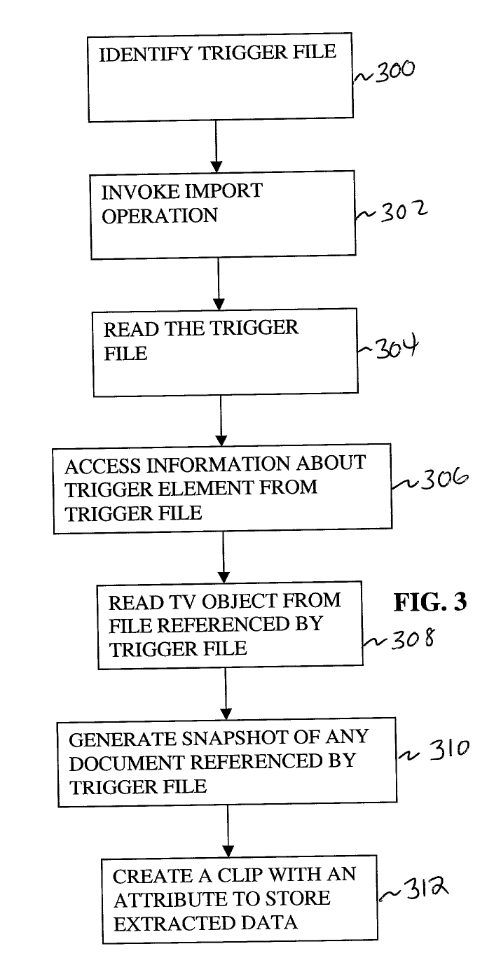

The process of importing information from a trigger file into a bin will now be described in connection with FIG. 3. A user first identifies 300 a trigger file using any conventional technique to locate the file. An import operation is then invoked 302. The import operation reads 304 the trigger file to access the information defined in FIG. 2A for each trigger element. If a trigger element specifies a file, for example using a URL, at 200, that file may be accessed 306 to obtain the information described in FIG. 2B. In particular, any “TV:” object in the specified file specifies the dimension and position of the video and is read 308 to obtain that value. A snapshot of the document defined by any specified file may be generated 310 by applying the document to a conventional browser object and storing the output from the browser object as an image file associated with the trigger element. It is possible to access and import the entire specified file and files referenced within the specified file for later use. Referenced files might be imported to protect against subsequent unavailability of the specified file or referenced files. Whether the import process includes capturing of HTML data referenced by the URL 200, or the files referred to by the document at the URL 200 may be at the user's selection through an appropriate user interface. A clip is then created 312 in the bin, with attributes that store the information about the trigger element, including its UID, and optionally the data describing the file associated by the URL. Each clip so created also may have its own unique identifier assigned by the editing application, which is different from the UID for trigger elements.

It is also possible to import only the HTML data (or other information) for interactive content that is not a trigger element. For example, a document in a markup language may be accessed through conventional techniques for locating its file. Files accessed in this manner include any files referenced by a file referenced by a trigger element. The file then may be read to extract information that is stored as an attribute of a clip in the bin.

After interactive content is imported into a bin as interactive clips, a user may access the interactive clips through an editing application to add interactive content to a program being edited. Addition of such elements to a program may be limited to a designated interactive track (e.g., 112 in FIG. 1). On an interactive track, interactive content may be added as one of a number of types of objects, such as a source clip object or a locator object. A source clip is an object that references a clip in a bin and has a start position and duration in the track. A source clip also may have attributes. A locator object is an object that is attached to a clip in the timeline at a specified point in time on the clip. A locator object also may have attributes. A trigger clip in a bin appears as a locator object on the timeline, and the attributes of the trigger clip are transferred to the locator object. An HTML clip in a bin appears as a source clip object on the timeline, and its attributes are transferred to the source clip object. A linked trigger clip in a bin may appear, upon a user's selection, as either a source clip object or a locator object on a timeline. The user's selection may be obtained through any appropriate user interface. The HTML and information about the trigger element is stored as attributes on either the source clip object or locator object. By placing interactive content on the interactive track in this manner, operations such as trimming, splicing and overwriting of time-based media may be used in their conventional manner to maintain synchronization between the interactive content and the time-based media.

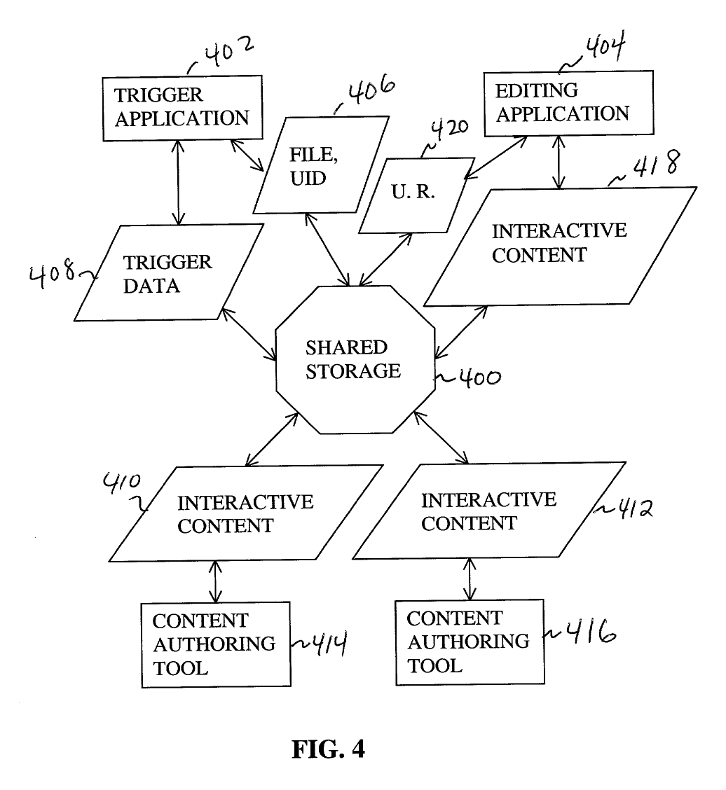

Referring now to FIG. 4, an example system for simultaneous authoring of time-based and interactive content for an interactive program is described. In this example, trigger files may be created and modified by the trigger application 402, described above, and stored on shared storage 400. The trigger application 402 uses the file name and UID 406 of a trigger element to access the shared storage for reading and/or writing of trigger data 408. Trigger elements may refer to content files 410 and 412 that are stored on the shared storage 400 or some other location. These files may be created and modified by editors using content authoring tools 414 and 416. An editing application 404, such as described above in connection with FIGS. 1-3, may be used to create and modify the interactive program by specifying a combination of time-based media and interactive content in the manner described above. Trigger files and content files 410 and 412 may be imported into a bin for the editing application 404, from which they may be selected for insertion into the interactive program. A unique reference (U.R. 420) for the interactive content, such as the trigger file name and UID for a trigger element, or other identifier (e.g., a URL) for interactive content that is not a trigger element, may be used by the editing application to read, in a manner described in more detail below, the interactive content 418 into the bin.

The editing application also may be programmed to launch a content authoring tool associated with the interactive content that is stored in a bin or that is placed on an interactive track. For example, the editing application may be programmed to allow a user to use any conventional operation to select the content in the bin or on the interactive track. The editing application then can cause the associated authoring tool to launch, access and open for editing the interactive content associated with the object in the bin or on the interactive track.

If a program has been specified through the timeline interface described above, it may be played back, for example in the record window of FIG. 1. If the interactive content includes display information, such as shown in FIG. 2B, indicating information to be displayed with the video and a specification of size and position of the video, then this information may be used to control the display of the video at a given point in time. The specification of the size and position of the video is accessed corresponding to the given point in time in the program. The video and the display information of the interactive content are then displayed according to the specification and the given point in time in the program. Many points in time in the program may be played back in sequence, for example, by using techniques such as described in U.S. Pat. No. 5,045,940.

With such a system, multiple editors may be working on different parts of an interactive program at one time. Thus, interactive content files 410 and 412 or trigger files, or trigger elements within them, may change after they are imported into a bin of the editing application 404. However, the unique references for the interactive content in the bin, e.g., the trigger file name and UID for a trigger element or the URL for a document, may be used to obtain updated interactive content from its source. This updating process is called a refresh operation. The refresh operation is similar to an import operation except for the method of identification of the trigger file. In a refresh operation information for all of the interactive content that has been selected for refresh is extracted again from currently available sources that correspond to the identifiers associated with the interactive content, e.g., the UID for a trigger element or the URL for a document.

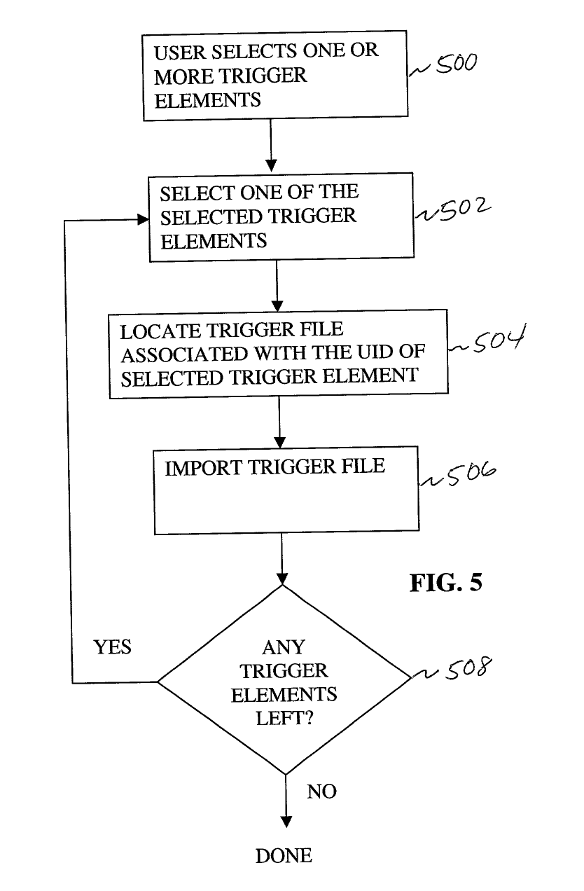

Referring to FIG. 5, to perform a refresh operation on trigger elements, the user may select 500 one or more trigger elements to be refreshed, for example by selecting a particular trigger element, all trigger clips with the same UID, or all trigger elements on a track or all trigger elements in a bin. One of the selected trigger elements is selected 502. The trigger file name and the UID of the selected trigger element is used to locate 504 the trigger file from the shared storage (400 in FIG. 4). The trigger element is then imported 506 in the same manner as described above in connection with FIG. 3. If no trigger elements remain to be refreshed, as determined in 508, the refresh operation is complete, otherwise, the next trigger element of the selected trigger elements is then selected 502 and the steps 502-508 are repeated. Similar operations also can be performed on other interactive content using an identifier, e.g., a URL, for the interactive content.

Upon completion of the editing of a program that includes both interactive content and time-based media, it is possible that there are many possible distribution formats for the program. Therefore, the program may be transformed from its specification in the editing system, using the program data structures, interactive content and trigger elements, into one or more encoded distribution formats, such as ATVEF, WebTV, Liberate, broadband interactive TV formats, or other format specified for the particular distribution channel, using conventional encoding techniques.

Such a system may be implemented using a computer program on a general purpose computer. Such a computer system typically includes a processor, an input device, a display device, and a memory. The memory stores software for performing the various functions described above. The computer display device displays a software generated user interface such as shown in FIG. 1 to accommodate the functionality.

The computer system may be a general purpose computer which is available from a number of computer system manufacturers as is well known by those of ordinary skill in the art. The computer system executes an operating system, such as Windows NT by Microsoft Corporation, MAC OS X by Apple Computer, Solaris by Sun Microsytems, Inc., IRIX by Silicon Graphics, Inc., or a version of UNIX. The invention is not limited to any particular computer system or operating system. The memory stores data and instructions. The memory may include both a volatile memory such as RAM and non-volatile memory such as a ROM, a magnetic disk, an optical disk, a CD-ROM or the like. The input device allows the user to interact with the computer system. The input device may include, for example, one or more of a keyboard, a mouse, or a trackball. The display device displays a user interface. The display device may include, for example, a cathode ray tube (CRT), a flat panel display, or some other display device.

Having now described an example embodiment, it should be apparent to those skilled in the art that the foregoing is merely illustrative and not limiting, having been presented by way of example only. Numerous modifications and other embodiments are within the scope of one of ordinary skill in the art and are contemplated as falling within the scope of the invention.

APPENDIX A
<?xml version=“1.0” encoding=“UTF-8”?>
<!−−

!! The trigger-list includes none, one, or many triggers
!! A trigger is represented by
!! <URL> [attr1 : val1][attr2 : val2]...[attrn : valn][checksum]

−−>
<!ELEMENT trigger-list (trigger)*>
<!ELEMENT trigger ((url) | (name)? | (expires)? | (script)? | (checksum)?
| (user-data)?)>
<!ELEMENT url (#PCDATA)>
<!ELEMENT name (#PCDATA)>
<!ELEMENT expires ((date)? | (time)?)>
<!ELEMENT date (year, month, day)>
<!ELEMENT year (#PCDATA)>
<!ELEMENT month (#PCDATA)>
<!ELEMENT day (#PCDATA)>
<!ELEMENT time (hours, minutes, (seconds)?)>
<!ELEMENT hours (#PCDATA)>
<!ELEMENT minutes (#PCDATA)>
<!ELEMENT seconds (#PCDATA)>
<!ELEMENT script (#PCDATA)>
<!ELEMENT id (#PCDATA)>
<!ELEMENT checksum (#PCDATA)>

What is claimed is:

1. An editing system comprising:
a timeline interface having at least one interactive track for interactive content and at least one track for time-based media, wherein interactive content may be associated with a point in time on the at least one track for interactive content; and
means for allowing a user to place interactive content on the at least one interactive track according to a selection of whether the interactive content is associated with either a point in time with a locator object or a duration with a source clip object on the at least one interactive track.

2. The editing system of claim 1, further comprising:
a bin for storing interactive content;
means for importing interactive content into the bin such that interactive content in the bin is associated with a unique reference;
wherein the means for allowing a user to place interactive content the at least one interactive track accesses the interactive content from the bin; and
means for updating information about the interactive content in the bin using the unique reference.

3. The editing system of claim 2, wherein the interactive content is a trigger element and the unique reference includes a file name for a trigger file including a description of the trigger element and a unique identifier of the trigger element.

4. The editing system of claim 2, wherein the interactive content is a document and the unique reference includes a file name for the document.

5. The editing system of claim 1, further comprising:
a bin for storing interactive content;
means for importing interactive content into the bin such that information about the interactive content is stored in the bin;
wherein the means for allowing a user to place interactive content the at least one interactive track stores information about the interactive content as an attribute of the object used for the interactive content.

6. The editing system of claim 1, wherein interactive content includes display information indicating information to be displayed with the video and a specification of size and position of the video, and the editing system further comprising:
means for playing back the program specified by the timeline interface including:
means for accessing the specification of the size and position of the video for the interactive content corresponding to a point in time in the program; and
means for displaying the video and the display information of the interactive content according to the specification and the point in time in the program.

7. An editing system comprising:
a timeline interface for specifying a program having at least one interactive track for interactive content and at least one track for time-based media, wherein interactive content may be associated with a point in time on the at least one interactive track;
a bin for storing interactive content;
means for importing interactive content into the bin such that interactive content in the bin is associated with a unique reference;
means for allowing a user to place interactive content selected from the bin on the at least one interactive track; and
means for updating information about the interactive content in the bin using the unique reference.

8. The editing system of claim 7, wherein the interactive content is a trigger element and the unique reference includes a file name for a trigger file including a description of the trigger element and a unique identifier of the trigger element.

9. The editing system of claim 7, wherein the interactive content is a document and the unique reference includes a file name for the document.

10. An editing system comprising:
a timeline interface for specifying a program having at least one interactive track for interactive content and at least one track for video, wherein interactive content may be associated with a point in time on the at least one interactive track;
means for allowing a user to place interactive content on the at least one interactive track, wherein interactive content includes display information indicating information to be displayed with the video and a specification of size and position of the video; and
means for playing back the program specified by the timeline interface including:
means for accessing the specification of the size and position of the video for the interactive content corresponding to a point in time in the program; and
means for displaying the video and the display information of the interactive content according to the specification and the point in time in the program.

11. The editing system of claim 10, further comprising:
means for allowing a user to select interactive content;
means for launching an authoring tool corresponding to the selected interactive content, and for causing the authoring tool to access and open for editing the selected interactive content.

12. The editing system of claim 1, further comprising:
means for allowing the user to place time-based media on a track using one of a source clip object and a locator object; and
means for allowing the user to perform editing operations that affect source clip objects and locator objects, whereby interactive content and time-based media are edited in the same manner to maintain synchronization.
